(19) United States
(12) Patent Application Publication
(10) Pub. No.: US 2017/0349805 A1
(43) Pub. Date: Dec. 7, 2017

(54) APPLICATION OF GROUND EXPANDING AGENTS IN CEMENT

(71) Applicant: SCHLUMBERGER TECHNOLOGY CORPORATION, Sugar Land, TX (US)

(72) Inventors: Simone Musso, Cambridge, MA (US); Jeffrey J. Thomas, Winchester, MA (US)

(21) Appl. No.: 15/171,014

(22) Filed: Jun. 2, 2016

(51) Int. Cl. C09K 8/467; E21B 33/14; C04B 20/00; C04B 103/42; C04B 103/00

(52) U.S. Cl. CPC C09K 8/467; E21B 33/14; C04B 20/0004; C04B 2103/0035; C04B 2103/42

(57) ABSTRACT

Embodiments may include cement compositions containing an expanding agent encapsulated with a polymeric material, wherein the polymeric material is permeable to aqueous fluids. Methods may include emplacing a cement slurry into a wellbore traversing a subterranean formation, wherein the cement slurry contains an expanding agent encapsulated with a polymeric material, wherein the polymeric material is permeable to aqueous fluids; allowing the cement slurry to harden; contacting the expanding agent encapsulated with a polymeric material with an aqueous fluid; and allowing the expanding agent to hydrate.

### BACKGROUND

Cements and cement composites are useful as structural materials for a variety of applications where settable materials with high compressive strength are desired. In some instances, a number of additives may be combined with cement that change various properties such as increasing flexural and tensile strength, modifying the setting time, or changing the rheological properties of a cement slurry prior to application.

In oilfield applications, cementing operations are often conducted after drilling of a wellbore has been completed. During completions operations, for example, a wellbore may be cased with a number of lengths of pipe prior to injection of a cement slurry. After placement of casing, the casing may be secured to the surrounding earth formations during primary cementing operations by pumping a cement slurry into an annulus between the casing and the surrounding formations that then hardens to retain the casing in position. The cement composition may then be allowed to solidify in the annular space, thereby forming a sheath of cement that prevents the migration of fluid between zones or formations previously penetrated by the wellbore.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments of the present disclosure are directed to cement compositions containing an expanding agent encapsulated with a polymeric material, wherein the polymeric material is permeable to aqueous fluids.

In another aspect, embodiments of the present disclosure are directed to emplacing a cement slurry into a wellbore traversing a subterranean formation, wherein the cement slurry contains an expanding agent encapsulated with a polymeric material, wherein the polymeric material is permeable to aqueous fluids; allowing the cement slurry to harden; contacting the expanding agent encapsulated with a polymeric material with an aqueous fluid; and allowing the expanding agent to hydrate.

Other aspects and advantages of the invention will be apparent from the following description and the appended claims.

### BRIEF DESCRIPTION OF THE DRAWINGS

The subject disclosure is further described in the detailed description which follows, in reference to the noted plurality of drawings by way of non-limiting examples of the subject disclosure, in which like reference numerals represent similar parts throughout the several views of the drawings.

FIG. 1 is a graphical representation depicting hydration kinetics of polymer-encapsulated expanding agents in accordance with embodiments of the present disclosure; and

FIG. 2 is a graphical representation of compressive load and stress over time for a cement slurry containing polymer-encapsulated expanding agents in accordance with embodiments of the present disclosure.

### DETAILED DESCRIPTION

The particulars shown herein are by way of example and for purposes of illustrative discussion of the examples of the subject disclosure only and are presented in the cause of providing what is believed to be the most useful and readily understood description of the principles and conceptual aspects of the subject disclosure. In this regard, no attempt is made to show structural details in more detail than is necessary, the description taken with the drawings making apparent to those skilled in the art how the several forms of the subject disclosure may be embodied in practice. Furthermore, like reference numbers and designations in the various drawings indicate like elements.

Embodiments disclosed herein are directed to methods for preparing and using cement containing a polymer-encapsulated expanding agent. Expanding agents in accordance with the present disclosure are materials that increase in volume when exposed to a triggering stimuli, which depending on the chemistry of the selected expanding agent may include an aqueous or non-aqueous fluid. In one or more embodiments, cement compositions may include expanding agents that are coated with a polymeric material that controls access of free water to an expanding agent embedded or encapsulated in the polymeric material.

The use of expanding agent particles encapsulated in rubber or other polymeric materials may carry several advantages including mitigating gelation and hydrate formation in a cement slurry that can result from direct contact between an expanding agent and a water source. In addition, by slowing the hydration of the expanding agent, encapsulation may also increase the effectiveness of the expansion by allowing the cement matrix to harden first, which may maximize the internal force exerted against the cement matrix by the reacting expanding agent. Moreover, the polymer encapsulant may also function to lower elastic modulus and reduce a tendency of the hardened cement composition to fracture.

Depending on the structural properties of the cement used to construct a cement sheath, a cement job may fail in response to changes in downhole conditions such as variations in temperature and pressure. For example, large increases in wellbore pressure or temperature and tectonic stresses may cause cracks to form in the sheath and cause shear failure or tensile stresses. Further, bulk shrinkage of the cement or pressure and temperature variations of fluids within the casing or the hydrating cement may cause debonding of the cement sheath from the formation or casing and the formation of microannuli. Defects in cementing operations such as debonding and cracking may hinder cement bond logging, create pressure instabilities, and may result in loss of zonal isolation in some cases.

Other causes of cement failure may include testing methods such as hydraulic pressure testing—a common test of zonal isolation—in which internal pressure is applied along the entire casing string. During testing, pressure may expand the casing, causing the cement sheath to experience tensile failure, which may lead to radial cracks and local debonding of the cement and casing in areas where the cracks are near the casing wall.

Methods in accordance with the present disclosure may address problems with cementing operations by using cement compositions containing an expanding agent that causes expansion of the cement after placement and improves wellbore sealing. Specifically, cement compositions containing expanding agents may provide several benefits, including, prevention and remediation of microannuli formation, creation of a positive compressive stress state in the cement that may reduce cracking and debonding, and improvement of the logging response by increasing and maintaining physical contact between cement and casing.

Cement composites in accordance with the present disclosure may be used in place of or in combination with cement formulations used in cementing applications in or outside of a wellbore and may reduce the risk of annular pressure buildup, sustained casing pressure (SCP), mechanical well damage, cement sheath failure, collapsed casing, tensile cracks, cement debonding, and reduce the need for costly remedial cementing jobs. When used in primary cementing operations, for example, at least a portion of the annular space between a casing and a formation wall may be filled with a cement composition containing an expanding agent, after which time the cement may then be allowed to solidify (often described interchangeably as curing or setting) in the annular space, thereby forming an annular sheath of cured cement.

In some embodiments, a cement composition containing a polymer-encapsulated expanding agent may be pumped into one or more annular regions within a wellbore such as, for example, (1) between a wellbore wall and one or more casing strings of pipe extending into a wellbore, or (2) between adjacent, concentric strings of pipe extending into a wellbore, or (3) in one or more of an A- or B-annulus (or greater number of annuli where present) created between one or more inner strings of pipe extending into a wellbore, which may be running in parallel or nominally in parallel with each other and may or may not be concentric or nominally concentric with the outer casing string.

### Polymer Encapsulant

In one or more embodiments, expanding agents in accordance with the present disclosure may be coated with a polymer encapsulant that modulates the reactivity of the expanding agent by acting as a permeable membrane that uses passive diffusion to limit the access of free water. Polymer encapsulants may also serve to modify the mechanical properties of the surrounding cement matrix, including elasticity and ductility. In some embodiments, polymer encapsulants may be homogenous polymers, blends or admixtures of multiple polymers, as well as copolymers, terpolymers, and multi-polymers containing varying types of comonomers.

In some embodiments, reactivity of a polymer-encapsulated expanding agent may be adjusted by increasing or decreasing the porosity of the matrix polymer and/or adjusting the loading of the expanding agent. Porosity of the matrix polymer may be adjusted to enhance or limit access of free water into the pores of the matrix polymer in order to tune the diffusion and/or degradation rate of the polymer. Modification of the matrix polymer porosity, and effective permeability to water, may be achieved in some embodiments by introducing chemical crosslinkers to create additional links between the chains of the matrix polymer to decrease the observed porosity. Porosity of a polymeric composite may also be increased similarly by methods known in the art such as the use of blowing agents or pneumatogens.

Polymer suitable for encapsulating expanding agents in accordance with the present disclosure may include nitrile butadiene rubber (NBR), hydrogenated nitrile butadiene rubber (HNBR), carboxylated nitrile rubber (XNBR), carboxylated hydrogenated nitrile rubber (XHNBR), silicone rubber, ethylene-propylene-diene copolymer (EPDM), fluoroelastomer (FKM, FEPM), perfluoroelastomer (FFKM), polymeric rubbers such as natural rubber, acrylate butadiene rubber, polyacrylate rubber, isoprene rubber, choloroprene rubber, neoprene rubber (CR), butyl rubber (IIR), brominated butyl rubber (BIIR), chlorinated butyl rubber (CIIR), chlorinated polyethylene (CM/CPE), styrene butadiene copolymer rubber (SBR), styrene butadiene block copolymer rubber, sulphonated polyethylene (CSM), ethylene acrylate rubber (EAM/AEM), epichlorohydrin ethylene oxide copolymer (CO, ECO), ethylene-propylene rubber (EPM and EDPM), ethylene-propylene-diene terpolymer rubber (EPT), ethylene vinyl acetate copolymer, fluorosilicone rubbers (FVMQ), silicone rubbers (VMQ), poly 2,2,1-bicyclo heptene (polynorborneane), alkylstyrene, and crosslinked substituted vinyl acrylate copolymers. Other polymer encapsulants may include polypropylene, polyethylene, polyethylene terephtalate, polyvinyl alcohol and polyaramid. Further, any of the above encapsulating polymers may also include reinforcing filler such as carbon black, silica, or fibers such as carbon fiber or metallic fibers.

In one or more embodiments, the polymeric material may be crosslinked following compounding with the expansion agent. For example, peroxide crosslinking agents such as Di Cup® 40KE available from Hardwick Standard Distribution Corp. (Akron, Ohio) may be used to modify the porosity and mechanical properties of a polymer encapsulant after the expanding agent has been compounded into the polymer by increasing the number of intra- and inter-strand crosslinks in the polymer material. A polymer encapsulant in accordance with the present disclosure may have a percentage of double bonds (unsaturation) remaining for crosslinking purposes that may range from 0.5% to 20% of the total number of bonds in the polymer material in some embodiments, and from 1% to 15% in other embodiments.

Crosslinking agents in accordance with the present disclosure may act on the polymer encapsulant by creating free radicals at sites along the backbone chain or side chains, which form intra- or inter-strand crosslinks in the polymer. Other crosslinking agents may include other free radical initiators, including peroxides, organic peroxides such as 2,5-dimethyl-2,5-di(2-ethylhexanoylperoxy)hexane, tert-butyl peroxy-2-ethylhexanoate, tert-amyl perbenzoate, tert-butyl perbenzoate, OO-tert-amyl-O(2-ethylhexyl) monoperoxycarbonate, OO-tert-butyl-O-isopropyl monoperoxycarbonate, OO-tert-butyl 1-(2-ethylhexyl) monoperoxycarbonate, poly(tert-butyl peroxycarbonate) polyether, decanoyl peroxide, lauroyl peroxide, succinic acid peroxide, 1,1-di(tert-butylperoxy)-3,3,5-trimethylcyclohexane, and the like. In other embodiments, crosslinking reagents may include azo initiators such as azobisisobutyronitrile, sulfur crosslinkers, carbon-carbon initiators such as diethyl 2,3-dicyano-2,3-diphenylsuccinate, and the like.

### Expanding Agents

In one or more embodiments, cement compositions in accordance with the present disclosure may include one or more expanding agents that are coated, encapsulated, or embedded in a polymeric material, or otherwise protected such that the access of free water to the expanding agent is controlled and occurs over a predetermined and/or defined time scale when the system containing the expanding agent is exposed to aqueous fluids. In some embodiments, polymer-encapsulated expanding agents may be used to tailor the effects of the expansive reactions on the chemical and mechanical properties of a cement matrix under a wide variety of downhole conditions, such as in response to expected ranges of temperature and pressure, and composition of connate or injected fluids present downhole.

In some embodiments, encapsulation of an expanding agent may slow hydration and preventing slurry gelation. Further, by delaying the reaction of the expanding agent and free water, the cement component of the composition may generate a cement matrix prior to the activation and expansion of the expanding agent. Delayed activation of the expanding agent may then maximize the use of the forces exerted during expansion, resulting in efficient transmission of force against the cement matrix. For example, an encapsulated expanding agent in accordance with the present disclosure, when emplaced in an annular space during completions operations, may cause the cement to expand and maintain contact with the casing and/or downhole formation walls, which can reduce the formation of micro-annuli that may result from shrinkage of the cement component following hydration.

Expanding agents in accordance with the present disclosure may be of the formula MX where M represents a divalent metal of one of the Periodic Table Groups 2, 8, 9, 10, 11, 12, and mixtures thereof; and X represents oxygen, hydroxide, or halide. Expanding agents may also be metal oxides that include, but are not limited to, Ca(OH)₂, Mg(OH)₂, CaCO₃, Al(OH)₃, MgO, MnO, CaO, ZnO, CuO, NiO, BeO, Fe₂O₃, and Al₂O₃. Expanding agents in accordance with the present disclosure may also include compounds that react with water to form hydroxides or hydrates with greater volume than the starting reactant such as calcium trisulfoaluminate hydrate. Other expanding agents may include expandable polymeric materials that swell in response to contact with aqueous or non-aqueous fluids, depending on the chemistry of the selected polymeric material.

The selection of the expanding agent may also depend on the temperature of the application. For example, while calcium oxide may react over a time scale that is impractical at higher temperatures, the kinetics of the hydration reaction may be workable for cementing applications when the expanding agent is encapsulated and used in lower temperature formations, such as those below 40° C.

In one or more embodiments, the reactivity of the expansion agent may be controlled by several mechanisms, including adjusting the particle size of the expanding agent and the polymer encapsulant, modifying the chemical nature of the polymer and expanding agent, modifying the amount of added polymer and or expanding agent, and adjusting the content of the expanding agent by supplementing additional polymer having no added expanding agent to tune the amount of polymeric material added without increasing the amount of expanding agent added.

The hydration kinetics, expanding properties, and slurry rheology of the expanding agent may depend on the average particle size and specific surface area of the powder. These in turn can be controlled by changing the calcination temperature used to form the powder and/or by grinding or sieving the powder after it has been calcinated. The activation of expanding agents in cementing operations may be controlled to take place in the first 48 h after mixing in some embodiments, which may lead to a beneficial compressive stress state when the cement composition is curing and improved structural qualities and logging response in the final set cement.

The surface area and/or average particle size may also be modified to tune the reactivity of the expanding agent. For example, the expanding agents such as MgO 291 and the MgO 298, commercially available from Magnesia GMBH (Luneburg, Germany), have the same average particle size (2.5 μm), yet the former has a much higher surface area, 55 m²/g, compared to 7 m²/g for the latter. The surface area for metal oxide expanding agents such as MgO may be tuned by adjusting the calcination temperature higher for lower internal porosity and increased density or lower where increased porosity and lower density is desired.

In one or more embodiments, the reactivity of the expanding agent may also be modified by increasing the surface area of the agent through grinding or milling to produce a powder or dust. For example, expanding agents that have been processed into fine powders will be highly reactive, i.e., having small particle size, high surface area, and ready accessibility for reaction.

In one or more embodiments, the size of the polymer-encapsulated expanding agents may have an average particle size, as determined by laser diffraction, sedimentation, or microscopy, for example, that ranges from a lower limit selected from 1 μm, 5 μm, 10 μm, 25 μm, 50 μm, or 100 μm, to an upper limit selected from 500 μm, 1 mm, 1.5 mm, or 2 mm, where the average particle size may range from any lower limit to any upper limit.

The expanding agent may be compounded with an amount of polymer encapsulant that ranges from 50 to 250 phr in some embodiments and from 75 to 190 phr in other embodiments. Further, the concentration of the polymer-encapsulated expanding agent by weight of cement (bwoc) may range from 2.5% to 55% bwoc in some embodiments, and from 5 to 50 wt % in other embodiments.

Cement compositions in accordance with the present embodiments may also be used to prepare a cement slurry prior to, during, or after placement by combining the cement composition with an aqueous fluid at a water to cement (w/c) ratio of 0.25 to 1.5 in some embodiments, and a w/c ratio of from 0.30 to 1 in other embodiments.

### Cements

Cement compositions in accordance with the present disclosure include hydraulic cements that cure or harden when exposed to aqueous conditions. In one or more embodiments, cement compositions disclosed herein may include a cement component that reacts with a water source, which may originate from an initial amount of water formulated as a component of a cement slurry or that is encountered downhole, and hardens to form a barrier that prevents the flow of gases or liquids within a wellbore. In some embodiments, the cement composition may be selected from hydraulic cements known in the art, such as those containing compounds of calcium, aluminum, silicon, oxygen and/or sulfur, which set and harden by reaction with water. These include “Portland cements,” such as normal Portland or rapid-hardening Portland cement, sulfate-resisting cement, and other modified Portland cements; high-alumina cements, high-alumina calcium-aluminate cements, Sorel cements such as those prepared from combinations of magnesia (MgO) and magnesium chloride (MgCl₂); and the same cements further containing small quantities of accelerators or retarders or air-entraining agents.

In one or more embodiments, cement compositions may include high temperature cements, such as Class G or H cements. Other cements that may be used in accordance with embodiments disclosed herein include phosphate cements and Portland cements containing secondary constituents such as fly ash, pozzolan, and the like. Other water-sensitive cements may contain aluminosilicates and silicates that include ASTM Class C fly ash, ASTM Class F fly ash, ground blast furnace slag, calcined clays, partially calcined clays (e.g., metakaolin), silica fume containing aluminum, natural aluminosilicate, feldspars, dehydrated feldspars, alumina and silica sols, synthetic aluminosilicate glass powder, zeolite, scoria, allophone, bentonite and pumice.

In one or more embodiments, the set time of the cement composition may be controlled by, for example, varying the grain size of the cement components, varying the temperature of the composition, or modifying the availability of the water from a selected water source. In other embodiments, the exothermic reaction of components included in the cement composition (e.g., magnesium oxide, calcium oxide) may be used to increase the temperature of the cement composition and thereby increase the rate of setting or hardening of the composition. Cement compositions may also include a variety of inorganic and organic aggregates, such as saw dust, wood flour, marble flour, sand, glass fibers, mineral fibers, and gravel. In some embodiments, a cement component may be used in conjunction with set retarders and viscosifiers known in the art to increase the workable set time of the cement. Cement compositions in accordance with the present disclosure may also contain additives that modify various properties of the final cement, including long chain fatty acids such as stearic acid, alkyl amines such as octamine, hydrocarbon resins, carbon blacks such as N330 Black, aromatic oils, and the like.

In some embodiments, cement compositions in accordance with the present disclosure may also contain hydrophillic, swelling polymers (sometimes referred to as “super absorbent polymers”). In some embodiments, an absorbent polymer may be used to draw aqueous fluids into the cement matrix and into contact with the expansion agent. For example, a super absorbent polymer, such as a polyacrylamide, may be used to accelerate the hydration kinetics of the expansion agent; however, absorbent polymers tend to form compressible hydrogels that decreases the expansive effect of the expansion agent.

Super absorbent polymers may include, for example, cationic, anionic or zwitterionic polymers, and non-limiting examples include Polyacrylic acid, polymethacrylic acid, polyacrylamide, polyethyleneoxide, polyethylene glycol, polypropylene oxide, poly(acrylic acid-co-acrylamide), polymers made from zwitterionic monomers which include N, N-dimethyl-N-acryloyloxyethyl-N-(3-sulfopropyl)-ammonium betaine, N,N-dimethyl-N-acrylamidopropyl-N-(2-carboxymethyl)-ammonium betaine, N,N-dimethyl-N-acrylamidopropyl-N-(3-sulfopropyl)-ammonium betaine, 2-(methylthio)ethyl methacryloyl-S-(sulfopropyl)-sulfonium betaine, 2-[(2-acryloylethyl)dimethylammonio]ethyl 2-methyl phosphate, [(2-acryloylethyl)dimethylammonio]methyl phosphonic acid, 2-(acryloyloxyethyl)-2′-(trimethylammonium)ethyl phosphate, 2-methacryloyloxyethyl phosphorylcholine, 2-[(3-acrylamidopropyl)dimethylammonio]ethyl 2′-isopropyl phosphate, 1-vinyl-3-(3-sulfopropyl)imidazolium hydroxide, (2-acryloxyethyl)carboxymethyl methyl sulfonium chloride, 1-(3-sulfopropyl)-2-vinylpyridinium betaine, N-(4-sulfobutyl)-N-methyl-N,N-di allyl amine ammonium betaine, N,N-diallyl-N-methyl-N-(2-sulfoethyl)ammonium betaine and the like. Superabsorbent polymers are hydrophilic networks which can absorb and retain huge amounts of water or aqueous solutions.

### EXAMPLES

In the following examples, the hydration kinetics and expanding properties of a polymer-encapsulated expanding agent were studied by analyzing samples of hydrogenated butadiene-acrylonitrile rubber (HNBR) polymer containing an MgO expanding agent and various additives.

The HNBR used in these studies contained a small percentage of double bonds (less than 5%) left for cross-linking purposes. In comparison to conventional elastomers such as acrylic and fluorocarbon materials, HNBR cured with both peroxide and sulfur agents has greater tensile strength, flexibility, wear resistance and resistance to fluids containing chemically aggressive additives. HNBR is a hydrophobic polymer that exhibits negligible volume change when exposed to water. However, water can diffuse into HNBR and hydrate reactive particles, such as MgO or cement, compounded into the material.

Assayed samples of HNBR contained a particulate magnesium oxide having an average particle size of 10 μm of hard-burned MgO and other additives. The HNBR was compounded and formed into sheets by Burke Industries according to the formulations listed in Table 1. Polymer composite sheets generated after compounding were then ground in a cryogrinder cooled by liquid nitrogen until a homogenous powder with average particle size of about 0.5 mm was obtained.

TABLE 1
Composition of HNBR with Compounded MgO inside

| | Sample 1 | Sample 2 |
|---|---|---|
| Component | (phr) | (phr) |
| HNBR Therban C 43% CAN | 100 | 100 |
| Hard-burned MgO | 190 (54.9% w/w) | 190 (49.2% w/w) |
| Carbon Black (N330) | 35 | 35 |
| Super Absorbent Polymer | 0 | 40 |
| Additives | 11.4 | 11.4 |
| Di Cup 40 KE | 10 | 10 |
| Total | 346.4 | 386.4 |

Composite materials Sample 1 and Sample 2 in Table 1 contain, among some additives used for compounding purposes, 190 parts per hundred of HNBR (phr) of hard-burned MgO, 35 phr of carbon black, and 10 phr of peroxide initiator Di Cup 40 KE.

Samples 1 and 2 differ by the presence of a super absorbent polymer (SAP), and Sample 2 contains 40 phr of SAP. When contacted with water, the SAP forms a hydrogel and absorbs aqueous solutions through hydrogen bonding. The ionic concentration of the aqueous solution may control the amount of water that the SAP can absorb. For example, in deionized and/or distilled water, a SAP may absorb 500 times its weight (from 30-60 times its own volume) and can become up to 99.9% liquid, but is less effective at absorbing concentrated solutions such as brines. As will be shown below, the presence of SAP accelerates the rate of hydration of the MgO particles embedded in the rubber, but has a negative effect on the expanding properties of the compound

### Example 1—Reactivity of Polymer-Encapsulated Expanding Agent

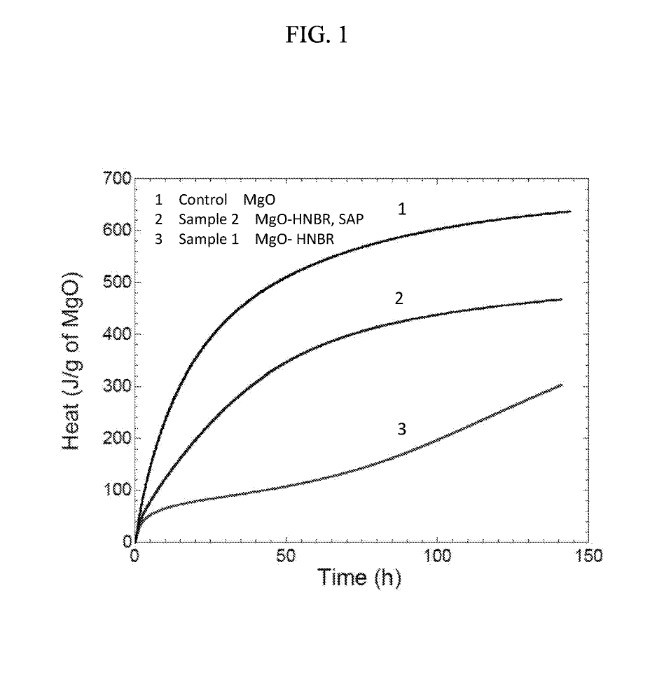

The first experiment tested the reactivity of the ground HNBR-MgO materials listed in Table 1 by hydrating them at 85° C. in a calorimeter and comparing the results to a control reaction of hard-burned MgO without encapsulation. These results are shown in FIG. 1. The calorimetry data is normalized to the mass of MgO present in the material, which is the reactive component. For Samples 1 and 2, the mass fraction of MgO is 54.9% and 49.2%, respectively as shown in Table 1. While both compounds hydrate more slowly than pure MgO, the presence of the superabsorbent polymer (SAP) in compound Sample 2 increases the reaction rate, which is attributed to the SAP drawing water into the HNBR matrix and increasing the availability of free water to react with MgO.

### Example 2—Expansion Characterization of Measurements of Polymer-Encapsulated Expanding Agent in a Cement Formulation

To measure the expanding properties, the HNBR/MgO Samples 1 and 2 were added to Class G cement in the amount of 25% by weight of cement (bwoc) and tested in a confined expansion cell, described below and in U.S. Pat. Pub. 2015/0027217, to analyze the expansion stress generated by these cement formulations. Results of the polymer-encapsulated cements were compared with a control cement formulation containing a similar amount of non-encapsulated MgO. The confinement cell included a thick-walled steel cylinder that provided radial confinement, along with a steel bottom plug that confined the sample from below. A steel piston contacted the sample from above, such that the sample is confined from all directions. The piston was connected to a mechanical testing device that controlled the axial force and displacement. After placing cement slurry into the cylinder, the compressive load applied by the piston and the corresponding internal compressive stress in the pastes was measured as a function of time while maintaining fixed displacement of the piston. The steel cylinder and cement sample contained therein were maintained at 85° C., and the sample was kept saturated with water through holes in the piston. These experimental conditions are designed to mimic oilwell cement placed against a stiff, water-filled formation.

The polymer-encapsulated expanding agents contain about 50 wt % MgO, and the effective amount of MgO effectively contained in the cement is approximately 12.5 wt %. All samples were prepared with a water to cement ratio (w/c) of 0.46. The control sample was formulated with 14% bwoc of hard-burned MgO, Sample 1 contained 25% bwoc of HNBR-MgO without SAP, and Sample 2 contained 25% bwoc of HNBR-MgO with 40 phr SAP.

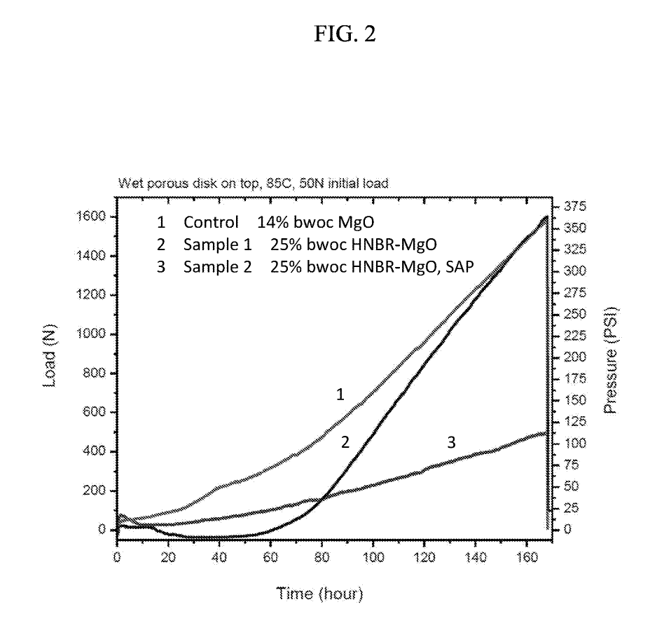

With particular respect to FIG. 2, Sample 2 containing the SAP showed initial stress generation greater than Sample 1 without SAP. That is likely due to the fact that SAP was accelerating the water absorption through the HNBR matrix and facilitating the hydration of MgO. However, after about 50 hours the rate of compressive stress generated by Sample 1 without SAP was greater than Sample 2 with SAP, and after 80 hours Sample 1 without SAP shows a greater stress than Sample 2 with SAP. This behavior is likely due to the fact that as SAP absorbs water it becomes a hydrogel with very low stiffness. Consequently, the internal stress is lower as the expanding agent presses against a compressible polymer gel. During the first several days, the control sample containing pure MgO produces a greater stress than the samples containing encapsulated MgO, however, after 168 hours the stress developed by the control cement-MgO sample is identical to that of the HNBR-MgO without SAP (Sample 1).

Although only a few examples have been described in detail above, those skilled in the art will readily appreciate that many modifications are possible in the examples without materially departing from this subject disclosure. Accordingly, all such modifications are intended to be included within the scope of this disclosure as defined in the following claims.

In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112(f) for any limitations of any of the claims herein, except for those in which the claim expressly uses the words ‘means for’ together with an associated function.

1. A composition comprising:
a cement slurry comprising an expanding agent encapsulated with a polymeric material, wherein the polymeric material is permeable to aqueous fluids.

2. The composition of claim 1, wherein the expanding agent is one or more selected from a group consisting of MgO and CaO.

3. The composition of claim 1, wherein the polymeric material is one or more selected from a group consisting of nitrile butadiene rubber, hydrogenated nitrile butadiene rubber, carboxylated nitrile rubber, carboxylated hydrogenated nitrile rubber, silicone rubber, ethylene-propylene-diene copolymer, fluoroelastomer, and perfluoroelastomer.

4. The composition of claim 1, wherein the expanding agent encapsulated with a polymeric material comprises polymeric material that has been crosslinked following compounding with the expansion agent.

5. The composition of claim 1, wherein the expanding agent encapsulated with a polymeric material comprises expanding agent compounded in an amount that ranges from 50 phr to 250 phr of polymeric material.

6. The composition of claim 1, wherein in the expanding agent encapsulated with a polymeric material is present in the cement slurry at a concentration in the range of 5% to 50% bwoc.

7. The composition of claim 1, wherein the average particle size of the expanding agent encapsulated with a polymeric material is within the range of 100 μm to 1 mm.

8. The composition of claim 1, wherein the w/c ratio of the cement slurry is from 0.30 to 1.

9. The composition of claim 1, wherein the cement slurry further comprises additional polymeric material free of expanding agent.

10. The composition of claim 1, further comprising a super absorbent polymer.

11. A method comprising:
emplacing a cement slurry into a wellbore traversing a subterranean formation, wherein the cement slurry comprises an expanding agent encapsulated with a polymeric material, wherein the polymeric material is permeable to aqueous fluids;
allowing the cement slurry to harden;
contacting the expanding agent encapsulated with a polymeric material with an aqueous fluid; and
allowing the expanding agent to hydrate.

12. The method of claim 11, wherein the cement slurry is injected into one or more annuli created within the subterranean formation.

13. The method of claim 11, wherein the expanding agent is one or more selected from a group consisting of MgO and CaO.

14. The method of claim 11, wherein the polymeric material is one or more selected from a group consisting of: nitrile butadiene rubber, hydrogenated nitrile butadiene rubber, carboxylated nitrile rubber, carboxylated hydrogenated nitrile rubber, silicone rubber, ethylene-propylene-diene copolymer, fluoroelastomer, and perfluoroelastomer.

15. The method of claim 11, wherein the expanding agent encapsulated with a polymeric material comprises expanding agent compounded in an amount that ranges from 50 phr to 250 phr of polymeric material.

16. The method of claim 11, wherein the expanding agent encapsulated with a polymeric material is present in the cement slurry at a concentration in the range of 5% to 50% bwoc.

17. The method of claim 11, wherein the average particle size of the expanding agent encapsulated with a polymeric material is within the range of 100 μm to 1 mm.

18. The method of claim 11, wherein the w/c ratio of the cement slurry is from 0.30 to 1.

19. The method of claim 11, further comprising a super absorbent polymer.

20. The method of claim 12, wherein the expanding agent encapsulated with a polymeric material comprises polymeric material that has been crosslinked following compounding with the expansion agent.

21. The method of claim 11, wherein the expanding agent encapsulated with a polymeric material prevents gelation of the cement slurry.

22. The method of claim 11, wherein the polymeric material controls a rate of hydration of the expanding agent.
